(19) United States
(12) Patent Application Publication
(10) Pub. No.: US 2015/0287114 A1
(43) Pub. Date: Oct. 8, 2015

(54) COMPUTER-IMPLEMENTED SYSTEM OF GROUPING BUYER REQUESTS MATCHING IN COMBINATION WITH A SELLER OFFER

(71) Applicant: Arnold Auer, Semriach (AT)

(72) Inventor: Arnold Auer, Semriach (AT)

(21) Appl. No.: 14/244,552

(22) Filed: Apr. 3, 2014

(51) Int. Cl. G06Q 30/06

(52) U.S. Cl. CPC G06Q 30/0613; G06Q 30/0605; G06Q 30/0611

(57) ABSTRACT

An apparatus for brokering between buyer nodes and seller nodes in a communication system, wherein the apparatus comprises a buyer node interface configured for receiving buyer requests from respective ones of the buyer nodes, each buyer request requesting buying a respectively specified product, a seller node interface configured for receiving seller offers from respective ones of the seller nodes, each seller offer offering sale of a respectively specified group of products, a buyer group formation unit configured for forming buyer groups, each formed by combining a plurality of the buyer requests meeting at least one common similarity criterion in terms of the products specified by the buyer requests of a respective buyer group, and a broker unit adapted for, upon determining a match between the products requested by the buyer requests of a buyer group and a group of products specified by a respective one of the seller offers, brokering a sale of the respective group of products from the seller node to the buyer nodes corresponding to the plurality of buyer requests of the respective buyer group via the communication network.

The invention relates to an apparatus for brokering between buyer nodes and seller nodes in a communication system.

Furthermore, the invention relates to a communication system.

Moreover, the invention relates to a method of brokering between buyer nodes and seller nodes in a communication system.

Beyond this, the invention relates to a program element.

Furthermore, the invention relates to a computer-readable medium.

In modern times, many products are sold over the Internet. However, conventional approaches are limited to products being offered via a website of a seller to individual users for a fixed or negotiable price.

There may be a need for a more flexible system of trading products over a communication network.

According to exemplary embodiments of the invention, an apparatus for and a method of brokering between buyer nodes and seller nodes in a communication system, a communication system, a program element, and a computer-readable medium according to the independent claims are provided.

According to an exemplary embodiment of the invention, an apparatus for brokering between buyer nodes and seller nodes in a communication system is provided, wherein the apparatus comprises a buyer node interface configured for receiving buyer requests from respective ones of the buyer nodes, each buyer request requesting buying a respectively specified product, a seller node interface configured for receiving seller offers from respective ones of the seller nodes, each seller offer offering sale of a respectively specified group of products, a buyer group formation unit (such as a processor or part thereof) configured for forming buyer groups, each formed by combining a plurality of the buyer requests meeting at least one common similarity criterion in terms of the products specified by the buyer requests of a respective buyer group, and a broker unit (such as a processor or part thereof) adapted for, upon determining a match between the products requested by the buyer requests of a buyer group and a group of products specified by a respective one of the seller offers, brokering a sale of the respective group of products from the seller node to the buyer nodes corresponding to the plurality of buyer requests of the respective buyer group via the communication network.

According to another exemplary embodiment of the invention, a communication system is provided which comprises an apparatus having the above mentioned features for brokering between buyer nodes and seller nodes in a communication network, the buyer nodes communicatively coupled with the apparatus via the communication network, and the seller nodes communicatively coupled with the apparatus via the communication network.

According to another exemplary embodiment of the invention, a computer-implemented method of brokering between buyer nodes and seller nodes in a communication network is provided, wherein the method comprises receiving buyer requests from respective ones of the buyer nodes, each buyer request requesting buying a respectively specified product, receiving seller offers from respective ones of the seller nodes, each seller offer offering sale of a respectively specified group of products, forming buyer groups, each formed by combining a plurality of the buyer requests meeting at least one common similarity criterion in terms of the products specified by the buyer requests of a respective buyer group, and, upon determining a match between the products requested by the buyer requests of a buyer group and a group of products specified by a respective one of the seller offers, brokering (in particular managing or coordinating the sale over the communication network) a sale of the respective group of products from the seller node to the buyer nodes corresponding to the plurality of buyer requests of the respective buyer group via the communication network.

According to still another exemplary embodiment of the invention, a program element (for instance a software routine, in source code or in executable code) is provided, which, when being executed by a processor (such as a microprocessor or a CPU), is adapted to control or carry out a method having the above mentioned features.

According to yet another exemplary embodiment of the invention, a computer-readable medium (for instance a CD, a DVD, a USB stick, a floppy disk or a harddisk) is provided, in which a computer program is stored which, when being executed by a processor (such as a microprocessor or a CPU), is adapted to control or carry out a method having the above mentioned features.

Data processing which may be performed according to embodiments of the invention can be realized by a computer program, that is by software, or by using one or more special electronic optimization circuits, that is in hardware, or in hybrid form, that is by means of software components and hardware components.

In the context of the present application, the term “buyer node” may particularly denote a communicatively coupled device, in particular an electronic device (for instance a computer such as a laptop or a portable user equipment such as a smartphone, a tablet PC, a convertible PC, or a TV), which is operable by a user and which is capable of communicating with the apparatus via a communication network such as the Internet so as to send buyer requests in the form of communication messages (such as emails, web messages, or telecommunication network messages) indicating the intention of a user operating the buyer node to acquire one or more certain products for a certain price.

In the context of the present application, the term “seller node” may particularly denote a communicatively coupled device, in particular an electronic device (for instance a computer such as a laptop or a portable user equipment such as a smartphone), configured to be operable by a user and to be capable of communicating with the apparatus via a communication network such as the Internet for transmitting communication messages (such as emails, web messages, or telecommunication network messages) indicating the intention of a user operating the seller device to sell a group of products for a certain group price to a group of buyers.

Both the buyer node or the seller node may for instance be a computer such as a desktop computer or a laptop, or a portable user equipment such as a tablet PC, a mobile phone, a personal digital assistant, etc.

In the context of the present application, the term “product” may particularly denote any commercially traded good or service. For example, the product may be a physical body such as a computer, a TV, a mobile phone, etc. A product may also be a service such as a ticket for a cultural event, a voucher for holidays, a booked hotel room, etc.

In the context of the present application, the term “similarity criterion” may particularly denote any criterion which is indicative of at least one predefined (for instance technical and/or commercial) property which products of corresponding buyer requests shall have in common so that the corresponding products can be grouped reasonably into a group of products. Examples for a similarity criterion are the identity of products (i.e. the same product type requested by the buyer nodes, for instance mobile phone xyz of manufacturer abc), a product genre (for instance USB sticks), a manufacturer of a product (for instance cars of manufacturer abc), etc. By applying one or more such or other similarity criteria to products related to various buyer requests, it can be determined whether or not there is a sufficient likelihood that the products meeting all the same similarity criterion are offered by one and the same seller via a seller offer. Each of various buyer requests with corresponding product(s) may therefore be assigned to or classified into one of various buyer groups based on one or more predefined similarity criteria. For instance, only one similarity criterion may be applied, such as an identity criterion requiring that all products of all buyer requests of a buyer group need to be identical. Alternatively, it is possible that a buyer request requesting a plurality of different products is assigned to more than one buyer group, for instance to a first buyer group concerning a first part of the requested products and a second buyer group concerning a second part of the requested products. Exemplary embodiments may also apply elements of artificial intelligence, such as fuzzy logic, in order to determine whether products relating to different buyer requests meet at least one common similarity criterion to a sufficient degree or not.

In the context of the present application, the term “node interface” may particularly denote a communicatively coupled interface to the buyer nodes/seller nodes which may include both a physical interface capable of sending and/or receiving communication messages and being capable of communicating in accordance with a certain communication protocol. The “buyer node interface” and the “seller node interface” may be the same interface or may be separate interfaces. Each of these interfaces may be a sender interface only, a receiver interface only, or a combined sender/receiver interface.

According to an exemplary embodiment of the invention, a computer-implemented apparatus (which may be embodied as an Internet platform) communicatively coupled via a communication network such as the public Internet may be provided which manages to bring together buyers' needs and sellers' needs in order to identify possible transactions in terms of the sale of products from an interested seller to a formed group of interested buyers. The operation of the apparatus via a communication network such as the Internet allows it to initiate sale transactions which would otherwise never take place due to the pronounced spatial distribution of different buyers and spatial distances between buyers and a seller. Grouping buyer requests to buyer groups and determining matches between the demands of a buyer group and one or more available seller offers allows to make trade over an anonymous communication network by formation of a community between buyer nodes assigned to buyers which need not know one another personally. Grouping of buyer requests is hereby possible without personal contact between users assigned to the buyer nodes. Furthermore, the interests of many (anonymous) buyers may be bundled so as to be able to obtain the acquired products for a better price by one common acquisition rather than multiple individual ones. For the seller nodes this has the advantage that product groups, involving very large numbers of products, may be sold in one single transaction, thereby rendering the logistics of each transaction simpler.

In the following, further exemplary embodiments of the apparatus, the method, the communication network, the computer-readable medium and the program element will be explained.

In an embodiment, the broker unit is adapted for brokering the sale only upon additionally determining a match between prices (or price ranges) offered by the buyer requests for the respective product of the buyer group and prices (or price ranges) offered by the seller offer for the respective product group. Thus, each of the buyer requests may not only indicate one or more products to be acquired, but also a price (or a range of acceptable prices) for which the potential buyer is willing to buy the one or more specified products. By determining matches between buyer groups and sale offers of seller nodes, not only the availability of the group of products from a single seller node is checked, but it can also be determined whether there is a potential pricing agreement between buyers and seller without the need of direct negotiations between seller nodes and buyer nodes.

In an embodiment, potential matches may also be determined in terms of one or more further criteria (in addition to products and pricing), such as logistics involved with a certain transaction (for instance only acquisitions of products may be considered for a potential match in which seller and buyers belong to the same jurisdiction, are located in sufficient spatial vicinity to one another, etc.) so as to keep the logistics sufficiently simple.

In an embodiment, the buyer node interface is configured for receiving a buyer group foundation request from a respective one of the buyer nodes defining a new buyer group to be founded in terms of type and amount of products and assigned prize or prize range, wherein the buyer group formation unit may be configured for founding the new buyer group in accordance with a received buyer group foundation request (in particular in form of a communication message from a buyer node received via the buyer node interface) and for inviting (for instance by specifically addressed communication messages or by a general, and anonymous, invitation via a web browser) further buyer nodes to send buyer requests joining the newly founded buyer group. A user initiated buyer group formation request may hence be used as a seed for the formation of the new buyer group. The platform offered by the apparatus may hence be used by a potential buyer to found a new buyer group by defining the type and amount of products to be acquired so that other buyer nodes may then join the buyer group, allowing the buyer group to grow. For example, the buyer node founding the new buyer group by a group foundation request may propose a transaction of for example 1000 specified laptops for a specified price, wherein the founding buyer node may only indicate its intention to buy one or a small number of such laptops. Other buyer nodes who are interested in acquiring this certain type of laptop for the proposed price can join the buyer group by transmitting a corresponding buyer request to the buyer node interface. A seller node being capable of delivering the 1000 laptops and being willing to sell them for the specified price can then send a corresponding seller request to the seller node interface. Thus, a match between the needs of the buyer nodes of the newly founded buyer group and the willingness of the user operating the seller node may then cause the broker unit to take the further necessary steps for brokering the sale.

In an embodiment, the buyer group formation unit is configured for terminating a newly founded buyer group when no match with a seller request is determined within a predefined time interval after foundation. If a certain threshold time interval (for instance one month) is exceeded since the foundation of the new buyer group without having determined a match, the newly founded buyer group may be terminated again. This prevents unnecessary data storage for buyer groups which apparently have no chance to find a match with a seller request. Additionally or alternatively to the time interval expired since the foundation of a new buyer group, one or more other criteria for terminating a newly founded buyer group can be applied or taken into account for deciding about termination of a buyer group, for instance the dynamics of new buyer requests joining a newly founded buyer group. If for instance the number of buyer nodes being interested in acquiring a product in accordance with the newly founded buyer group is below the required level of the buyer group (for instance if only 500 buyer nodes have indicated their intention to acquire the laptop for a certain price, but 1000 are required by a seller request), the apparatus may invite the buyer nodes being members of the buyer group to adjust their price offer (for instance to correspondingly increase the price offer) and/or may invite the seller node having made an offer in accordance with the buyer group to adjust the seller offer to the reduced number of members of the buyer group. Thereby, the apparatus may even trigger transactions which would not meet the initial offers, but are still acceptable for the buyer nodes and the seller node.

In an embodiment, the seller node interface is configured for receiving a buyer group foundation request (in particular in form of a communication message from a seller node received via the buyer node interface) from a respective one of the seller nodes defining a new buyer group to be founded in terms of type and amount of products and assigned prize or prize range, wherein the buyer group formation unit may be configured for founding the new buyer group in accordance with a received buyer group foundation request and for inviting (for instance by specifically addressed communication messages or by a general, and anonymous, invitation via a web browser) buyer nodes to send buyer requests joining the newly founded buyer group. Thus, formation of a new buyer group cannot only be initiated by a buyer node, but also by a seller node (for instance offering the sale of 1000 laptops for a certain price). Then, interested buyer nodes may send corresponding buyer requests to the buyer node interface and joining the seller founded buyer group, and if a sufficient number of appropriate buyer requests has been received via the buyer node interface, a match between the newly founded buyer group, constituted by the buyer nodes having sent a buyer request, and the mass offer of the seller node can be determined, so that the brokering unit may initiate the transaction.

In an embodiment, the buyer group formation unit is configured for terminating a newly founded buyer group when no match with buyer requests is determined within a predefined time interval after foundation. In order to keep the data storage resources of the apparatus small as well as the traffic over the communication network sufficiently small and to keep the lucidity of buyer groups for buyers and sellers as small as possible, even seller node initiated buyer groups can be terminated after expiry of a certain time limit after their formation when no match could be identified within a certain timeframe. This may keep the platform simple and may allow to automatically keep the platform clean from non-realistic seller offers. In an embodiment, when the presence of a required number of buyer nodes willing to acquire products according to the conditions specified by a seller founded buyer group cannot be determined within a predefined time interval, invitations may be sent to the initiating seller node and/or the buyer request sending buyer nodes to adapt or adjust their offers (for instance in terms of number of products, pricing, etc.) to increase the probability of a match.

In an embodiment, the broker unit is adapted for (in particular before or upon determining a match) invite the buyer nodes and/or the seller node to provide a legally binding confirmation of the buyer requests and/or the seller request. In one embodiment, the determination of a match between buyer requests and a seller request may trigger an invitation of the seller node and the buyer nodes to agree in a legally binding way to be willing to actually carry out the transaction or trade based on indicated conditions. Such a legally binding confirmation may be sent, in particular by a communication message transmitted over the communication network, in accordance with the legal requirements of a certain jurisdiction for the validity of electronic contracts (for instance involving a legally binding electronic signature). Alternatively, the apparatus may require such a legally binding declaration already at the point of time of sending seller requests or buyer requests to the apparatus.

In an embodiment, a corresponding seller request or buyer request is only displayed by the platform of the apparatus to seller nodes/buyer nodes after having provided such a legally binding declaration. By taking this measure, the reliability of the brokered transactions over a remote network of nodes operated by users which usually do not know each other personally can be improved, and the acceptance of the e-commerce trade system can be improved. Further, misuse of the system may be prevented by taking such a measure.

In an embodiment, the broker unit is adapted for, upon determining a match, inviting the buyer nodes to transfer a payment prize for the products of the respective group of products to a trust account (which may be operated or controlled by the apparatus) or directly to the seller node. Therefore, in the described embodiment, the apparatus may also trigger and monitor the payment procedure from a plurality of users of the user nodes to a respective user of the seller node. For example, upon determining a match and in the presence of legally binding requests, the apparatus may invite the buyer nodes to transfer the money to the seller nodes using an identifier identifying which buyer request corresponds to which money transaction. In another embodiment, the apparatus may invite the buyer nodes of a matching transaction to transfer the money to the trust account operated by the apparatus as well. In the latter scenario, transfer of the payment from the trust account to the seller node can be managed by the apparatus to occur only after having delivered the products from the seller node to the buyer nodes. By taking this measure, the acceptance of the system and the reliability of a correct transfer of money for products can be increased by involving the trust account. This also guarantees that the transactions may occur in an anonymous way.

In an embodiment, the broker unit is adapted for, upon determining a match, inviting the seller nodes to ship the products of the respective group of products from the seller node to a trustee destination (for instance a logistic center operated or controlled by the apparatus) or directly to the buyer nodes corresponding to the plurality of buyer requests. Hence, also the shipment of the products from the seller node to the buyer nodes may be triggered and organized by the broker unit. In one embodiment, the broker unit invites the seller node to ship the products to the respective buyer nodes. Upon receipt of the requested product by a respective buyer node, the buyer nodes can be invited to send a confirmation message to the apparatus which, in turn, may then initiate the transfer of the payment from the trust account to the seller node. Alternatively, the transaction of the money from the trust account to the seller node can be automatically initiated in the absence of any complaint message from any of the buyer nodes to the apparatus (wherein such a complaint message may indicate lack of delivery of the requested product to the respective buyer).

In yet another exemplary embodiment, the apparatus also controls the logistics of transferring the products from the seller node to the buyer nodes. In such an embodiment, the group of products may be delivered from the seller node to a trust destination such as a logistic center or unit operated or controlled by the apparatus. The logistics unit may then organize shipment of the products to the individual buyer nodes. The transfer of the money from the trust account to the seller node may in this case be initiated upon receipt of the products centrally by the logistics unit.

In an embodiment, the apparatus is configured to be communicatively coupled to the seller nodes and the buyer nodes via the Internet. However, it is also possible to perform transactions over other communication networks, such as a telecommunication network, an intranet, etc.

In an embodiment, the broker unit is adapted for, upon determining multiple matches between a buyer group and multiple seller offers, brokering the sale of the respective group of products from the seller node having offered the lowest prize for the group of products. Therefore, in the case of multiple conflicting seller requests all offering a group of products in accordance with the requirements of a buyer group, the cheapest seller request may be selected or a competition between the seller requests may be started requesting the seller nodes to make a better offer for the buyer nodes of a buyer group, so that the best offer is then determined as the actual match triggering a trade between the buyer nodes and the corresponding seller node. Amended offers may be requested and responded by the exchange of corresponding communication messages between the apparatus and the seller nodes.

In an embodiment, the buyer node interface is configured for extracting buyer node identities from the buyer requests. For example, it is possible that a buyer request is only accepted by the platform after a user has registered itself at the apparatus (for instance via a web form provided by the apparatus), thereby also indicating her or his identity. Alternatively, the identity of a user operating a buyer node may be automatically derived from the communication with the respective buyer note (for instance by determining a telephone number assigned to a buyer node configured as a mobile phone). By taking this measure, the reliability of buyer requests may be improved.

In an embodiment, the seller node interface is configured for extracting seller node identities from the seller requests. For example, it is possible that a seller offer is only accepted by the platform after a user has registered itself at the apparatus (for instance via a web form provided by the apparatus), thereby also indicating her or his identity. Alternatively, the identity of a user operating a seller node may be automatically derived from the communication with the respective seller note (for instance by determining a telephone number assigned to a seller node configured as a mobile phone). By taking this measure, the reliability of seller offers may be improved.

In an embodiment, the apparatus is configured for operating (in particular for managing a trade, potentially also involving managing money transfer and shipment of product) without indicating an identity of a buyer node to a seller node and/or an identity of a seller node to a buyer node. In particular prior to payment and/or shipment in terms of a certain trade following determination of a match, the anonymity of buyer nodes and seller nodes may be maintained. This embodiment guarantees an anonymous transaction between buyer nodes and a seller node and thereby is highly advantageous in terms of data safety. The identity of the seller nodes and the buyer nodes is then only known to the apparatus, functioning as a trusted entity. Therefore, it is possible for buyer nodes to make transactions without allowing any other third party to get knowledge about her or his identity.

In an embodiment, the buyer group formation unit is configured for forming buyer groups by combining a plurality of the buyer requests with specified products which are identical. For example, all buyers desiring to buy a specific type of TV device as product may be bundled to a group of products.

In another embodiment, the buyer group formation unit is configured for forming buyer groups by combining a plurality of the buyer requests with specified products which are different from one another but are all available from a common supply source. For example, all buyers wishing to acquire a car from a certain manufacturer may be bundled to a group of products, even if the individual car types requested by different buyer nodes differ. This allows to extend the range of possible transactions intermediated by the apparatus.

Under certain circumstances, it may happen that a formed buyer group does not match with a corresponding seller offer due to lack of an appropriate seller offer over a predefined time interval. The corresponding buyer group may then be terminated or closed. In such a scenario, the apparatus may send communication messages to the buyer nodes assigned to the buyer group indicating the fact that no match with an appropriate seller offer could be determined.

Under certain circumstances, it may happen that a formed buyer group of buyer nodes requesting products which correspond to only a part of a group of products of a corresponding seller offer does not find a sufficient number of buyers and assigned buyer nodes sending buyer requests over a predefined time interval. The corresponding buyer group may then be terminated or closed. In such a scenario, the apparatus may send communication messages to the seller node indicating that no sufficient number of buyers have filed suitable buyer requests in accordance with the seller offer. It is also possible that the apparatus sends communication messages to the buyer nodes assigned to the (too small) buyer group indicating the fact that no match with an appropriate seller offer could be determined due to lack of a sufficient number of interested buyer nodes.

Hence, buyer groups may be terminated upon identifying an unsuccessful relationship between the buyer group on the one hand and seller offers on the other hand, for example after expiry of a predefined time limit within which the apparatus searches for a match. However, also in such a scenario, a dynamic management of the formed buyer groups is possible so as to increase the probability of a successful match between buyer requests of the buyer group on the one hand and a seller offer on the other hand. For example, if the time limit has expired without identifying a successful match it is possible that the apparatus queries each of presently available other buyer groups and seller offers so as to determine, for instance for each of the buyer requests of an unsuccessful buyer group individually or for at least part of these buyer requests in combination, as to whether these unsuccessful buyer requests may be integrated in one of the other pending buyer groups or seller offers. By taking this measure, i.e. by a dynamic management of the buyer groups, the probability of successfully finding matches between buyer requests and seller offers can be significantly increased. Criteria for such a redistribution or regrouping of buyer requests are a degree of correlation between product and/or prize and/or timeframe of delivery of a buyer request versus group of product and/or prize and/or timeframe of delivery of a seller offer or of another buyer group. When a buyer request shall be redistributed or regrouped into and other buyer group, the corresponding buyer node may be notified accordingly, or maybe asked for approval for such a redistribution or regrouping.

The aspects defined above and further aspects of the invention are apparent from the examples of embodiment to be described hereinafter and are explained with reference to these examples of embodiment.

The invention will be described in more detail hereinafter with reference to examples of embodiment but to which the invention is not limited.

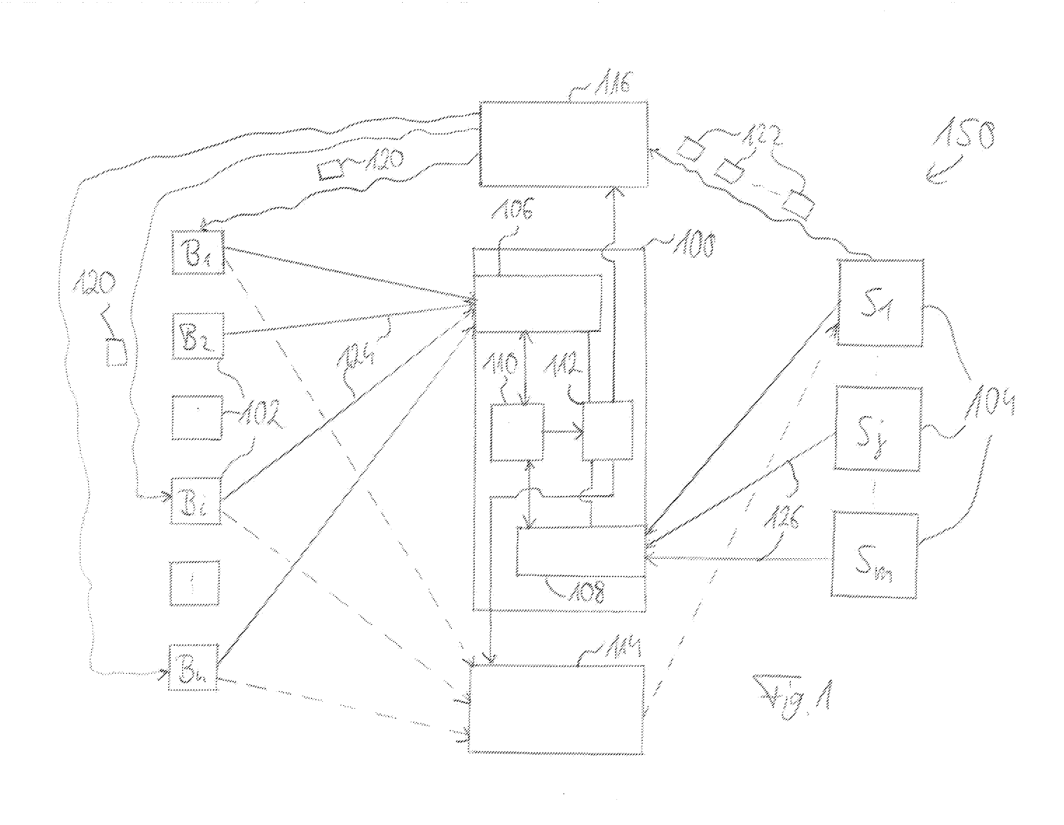

FIG. 1 shows a communication system according to an exemplary embodiment of the invention formed by a computer-implemented apparatus, a plurality of seller nodes and a plurality of buyer nodes communicatively coupled via a communication network, the apparatus coordinating transactions including logistics and payment between the plurality of buyer nodes and the plurality of seller nodes.

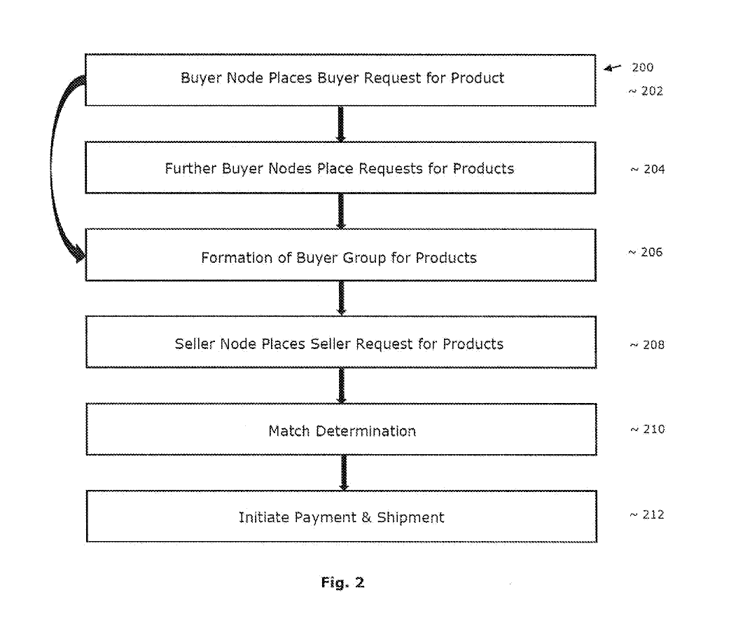

FIG. 2 is a block diagram of a computer-implemented method of trading between a plurality of seller nodes and a plurality of buyer nodes over a communication network according to an exemplary embodiment of the invention.

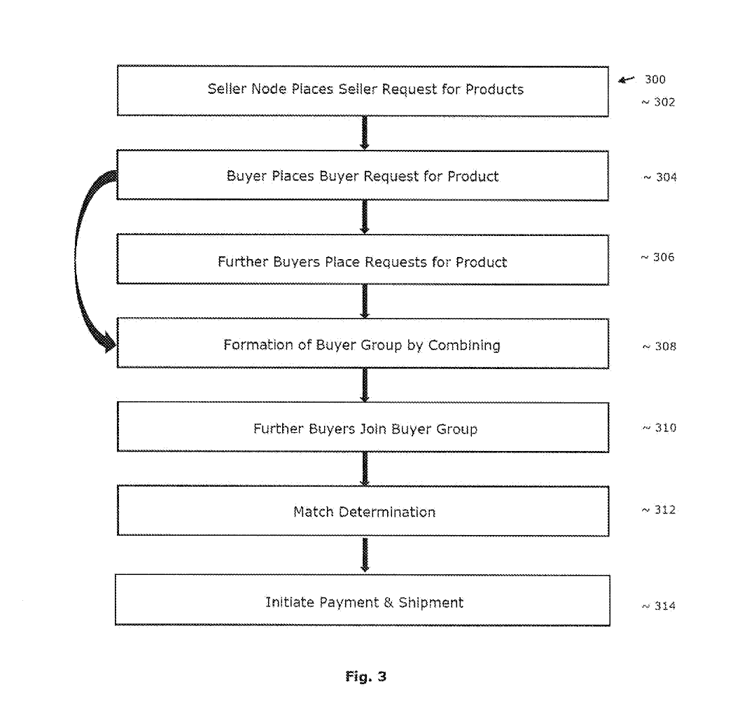

FIG. 3 is a block diagram of a computer-implemented method of trading between a plurality of seller nodes and a plurality of buyer nodes over a communication network according to another exemplary embodiment of the invention.

FIG. 4 to FIG. 7 show schemes illustrating trades between buyer nodes and seller nodes via a communication network, organized via a computer-implemented apparatus, according to other exemplary embodiments of the invention.

The illustrations in the drawings are schematical. In different drawings, similar or identical elements are provided with the same reference signs.

FIG. 1 shows a communication system 150 according to an exemplary embodiment of the invention formed by a computer-implemented apparatus 100, a plurality of seller nodes 104 (indicated as S₁, . . . , Sⱼ, . . . , Sₘ) and a plurality of buyer nodes 102 (indicated as B₁, B₂, . . . , Bᵢ, . . . , Bₙ) communicatively coupled via a communication network, wherein the apparatus 100 coordinates all communication related to commercial transactions including logistics and payment between the plurality of buyer nodes 102 and the plurality of seller nodes 104.

The communication system 150 comprises the apparatus 100 for brokering between the buyer nodes 102 and the seller nodes 104 over a communication network, here the public Internet. The apparatus 100 is configured as a computer node such as a server controlling the brokering. The buyer nodes 102, configured as computers or mobile user equipment, are communicatively coupled with the apparatus 100 via the communication network, and also the seller nodes 104, also configured as computers or user equipment, are also communicatively coupled with the apparatus 100 via the communication network.

Each of the apparatus 100, the buyer nodes 102 and the seller nodes 104 may have a processor which may be capable of executing program code stored on a storage device (not shown) of the corresponding apparatus 100 or node 102/104. A respective wired or wireless communication interface of the respective apparatus 100 and nodes 102/104 is configured for a wireless or wired communication over the communication network.

The apparatus 100 may correspond to an Internet platform offering trades to buyers operating the buyer nodes 102 and sellers operating the seller nodes 104 of products via the communication network, i.e. remotely and anonymously. The apparatus 100 may comprise a web interface via which the buyer nodes 102 and the seller nodes 104 may communicate with the apparatus 100. It is also possible that a software code (such as an App) is installed on the buyer nodes 102 and the seller notes 104 enabling communication with the apparatus 100.

The apparatus 100 has a buyer node interface 106 via which buyer requests 124 in the form of electronic communication messages can be received from respective ones of the buyer nodes 102. Each of the buyer requests 124 may include the intention of a user of the corresponding buyer node 102 to buy of a respectively specified product 120 (or more than one of such identical or different products 120) for a respectively specified price (which may be selected or indicated by the user of the respective buyer node 102).

The apparatus 100 furthermore comprises a seller node interface 108 which is configured for receiving seller offers 126 in the form of electronic communication messages from respective one of the seller nodes 104, wherein each seller offer may offer sale of a respectively specified group of products (usually a large number of products, for instance more than ten, in particular more than hundred, further particularly more than thousand products).

For instance, a buyer request may indicate the intention of the buyer operating the buyer node 102 to acquire one or more products (for instance one or more mobile phones of a specified type for a specified price). Correspondingly, each seller offer may include an offer of a large group of products, for example 100 mobile phones of a specific type for a specifically indicated group price. Since even large numbers of products (grouped to a corresponding group of products) can be offered for sale to groups of non-specified buyers via the communication network, the individual price for each product may be very attractive for users operating a buyer node 102.

A buyer group formation unit 110 of the apparatus 100 is configured for forming buyer groups based on buyer requests 124 and/or seller offers 126. Each buyer group may be formed by combining a plurality of the received buyer requests 124 based on the application of one or more similarity criteria which needs to be fulfilled by all buyer requests 124 grouped into a buyer group. Whether a similarity criterion is fulfilled by different buyer requests 124 may be determined by analyzing the buyer requests 124 in terms of products requested by the different buyer nodes. For instance, all buyer requests indicating the wish to buy a specific product (for instance a mobile phone type xyz of manufacturer abc) may be grouped into a buyer group. Other criteria for grouping multiple buyer requests 124 from multiple buyer nodes 102 into a common buyer group may be a location of the buyer nodes 102 assigned to the buyer requests 124, delivery time, indicated price or price range. For certain types of products it may be appropriate to group only buyer requests 124 from buyers of the same jurisdiction or located in the same country or district. In another embodiment, only buyer requests 124 related to identical products may be grouped in one buyer group, or products which are similar in accordance with one or more other criteria, for instance are all available from the same manufacturer or supply source.

A broker unit 112 is configured for comparing the formed buyer groups with the seller offers 126 in order to determine possible matches between products requested by the buyer requests 124 of a buyer group and a group of products specified by a respective one of the seller requests 126 for sale. The comparison may be made in terms of one or more matching criteria, such as match of products, match of prices or price ranges, match of jurisdictions, match of locations of seller and buyers, and/or match of delivery dates, etc.

If such a match is determined, the broker unit 112 may initiate brokering of the sale of the respective group of products from the seller node 104 to the buyer nodes 102 corresponding to the plurality of buyer requests 124 of the respective buyer group via the communication network. For example, if 100 buyers have independently from one another indicated the intention to buy a certain mobile phone for a certain price, and if a corresponding offer of a seller node 104 indicates the intention to sale 100 mobile phones for the specified price, the transaction can be initiated by the broker unit 110. For this purpose, the broker unit 110 may communicate via the transmission of communication messages to the involved buyer nodes 102 and the involved seller node 104 indicating that an agreement or a match has been achieved so that the transaction can be completed. It is also possible that communication messages are sent from the broker unit 110 to the buyer nodes 102 and the seller node 104 requesting to confirm, in a legally binding way, to be willing to make the transaction. The transaction may then be completed after the buyer nodes 102 and the seller node 104 have provided the legally binding declaration by response messages. Alternatively, a legally binding declaration of the buyer nodes 102 or the seller nodes 104 may be requested by the apparatus 100 before determining a match, for instance before placing the respective buyer requests 124 or seller offers 126 on the platform (for instance on a web browser).

As can be taken from FIG. 1, the apparatus 100 may also comprise a payment unit 114 which may be provided for organizing payment of the products when a match has been determined and the transaction is to be completed. For instance, communication messages may be sent from the payment unit 114 to the buyer nodes 102 forming part of the buyer group for which a match has been determined, and the buyer nodes 102 may be invited by such communication messages to transfer money either to the payment unit 114 (acting as a trusted entity managing a trusted account), or directly to the seller nodes 104. Upon receipt of the payment, the payment unit 114 may trigger the transfer of the products from the seller to the buyers. For example, communication messages may be sent from the payment unit 114 to the seller node 104 involved in the present transaction to initiate shipment of the group of products to the buyer nodes 102 involved. This can be made either directly, so that the addresses of the buyer nodes 102 involved in the transaction have to be transmitted from the payment unit 114 to the seller nodes 104.

Alternatively, a logistic unit 116 of the apparatus 100 may be involved which can invite the seller nodes 104, for instance after receipt of the money, to initiate the shipment of the group of products 122 to the logistic units 116. The logistic unit 116, being in possession of the identities (and for instance shipment address information or the like) of the buyer nodes 102 involved in the transaction may then organize shipment of the products to the individual buyer nodes 102 in accordance with the corresponding buyer requests 124 bundled to the buyer group. For instance, upon receipt of the products 120 forming part of the product group 122 from the respective seller node 104, the logistic unit 116 may also trigger the payment unit 114 to transfer the money received from the buyer nodes 102 to the seller node 104.

In the communication system 150 shown in FIG. 1, it is also possible that any of the buyer nodes 102 initiates foundation of a new buyer group. This can be done by sending a corresponding communication message from the respective buyer node 102 to the buyer node interface 106 defining a group of products and an assigned price for which the buyer node 102 would be willing to buy part of the group of products, for instance one or several of the products. Other buyer nodes 102 may then be invited, via a web page of the platform, to send buyer requests 124 to the buyer node interface 106 to indicate their intention to also buy one or several products of the group of products for the proposed price, i.e. to join the newly founded buyer group. Any seller node 104 willing to deliver the group of products for the indicated price, may then send a corresponding seller offer 126 to the seller node interface 108. When the brokering unit 112 determines a match between a seller offer 126 and a buyer group to which a sufficient number of buyer nodes 102 have declared their intention to buy a part of the products of the group of products, the transaction will be initiated.

In a corresponding way, it is possible to initiate a new buyer group by one of the seller nodes 104 as well, for instance offering a group of products for a certain group price. When a sufficient number of buyer nodes 102 have indicated the intention to buy a part of the products of the group of products according to this new buyer group, the transaction can be initiated upon determination of a corresponding match by the broker unit 112.

It should be said that the identity of the buyer nodes 102 and of the seller nodes 104 needs only be known by the apparatus 100, in particular when the payment and the logistics are managed by the payment unit 114 and the logistic unit 116, respectively. This keeps the identities of the operators of the buyer nodes 102 and of the seller nodes 104 secret and therefore protects the users' privacy, which is advantageous in terms of data safety.

It should be said that the various units (see in particular reference numerals 110, 112, 114, 116) can be embodied as separate entities (for instance arranged remotely from one another), can be grouped to form at least two groups of separate entities (wherein the different groups may be arranged remotely from one another), or can all be combined to one common entity. Each of these units may be configured as a separate processor, or the units may form part of one and the same processor. In other words, it is also possible that some of the units (for instance 114, 116) are combined to one entity, for instance one processor.

FIG. 2 illustrates a block diagram 200 of a computer-implemented method of trading between buyer nodes 102 and seller nodes 104 via a communication network such as the public Internet according to an exemplary embodiment of the invention.

As indicated by a block 202, a buyer node 102 may place a buyer request 124 for a certain product. As indicated by block 204, further buyer nodes 102 may place further buyer requests 124 for the same or similar products as well. As indicated by a block 206, a buyer group may be formed for a batch of products and assigned buyer requests 124 which meet one common similarity criterion (for instance identity of the products). After having established a buyer group, a seller node 104 may place a corresponding seller offer 126 or seller request for a group of products on the platform, see block 208. If a match can be determined between the group of products specified by the buyer group and a seller offer 126, also including a match of the pricing, see block 210, payment and shipment of individual products of the group of products may be initiated, see block 212, and the transaction may be completed.

FIG. 3 indicates a block diagram 300 of a computer-implemented method of trading between buyer nodes 102 and seller nodes 104 over a communication network according to another exemplary embodiment of the invention.

According to the block diagram 300, a seller node 104 may place a seller offer 126 or seller request for products on the platform, see block 302. As can be taken from a block 304, a buyer may place a buyer request 124 for products. Further buyers may place buyer requests 124 for such products on the platform as well, see block 306. Multiple of the received buyer requests 124 may be combined to batches of buyer requests 124, thereby forming a new buyer group, see block 308. Further buyers may join the buyer group, see block 310, i.e. may also indicate the intention to buy products for conditions defined by the buyer group. If a match is determined between a buyer group and a seller offer 126, see block 312, the transaction may be completed by initiating payment and shipment, see block 314.

In the following, some basic considerations of the present inventor will be described in the following referring to FIG. 4 to FIG. 7 based on which exemplary embodiments have been developed.

Generally, offers for acquisition and offers for sale meet each other for certain products in a commercial system. An equilibrium between products and price may be automatically formed by the number of sellers and the number of buyers, under consideration of the price. The price for a product will be high if there are more buyers willing to buy than sellers willing to sell. A lower price will be established if the number of buyers is smaller than the number of sellers. An equilibrium price will be established when there is a balanced number of sellers and buyers.

Due to globalization and communication of buyers and sellers via communication networks, an intransparency of the equilibrium between sellers and buyers occurs, caused by the large number of business options, the anonymous character of Internet trade, etc. Rules of conventional trading, such as on a market place, do not hold or apply any longer for trades via such a communication network. An exemplary embodiment overcomes this shortcoming of centralized decentralization of buyers and sellers via a communication network such as the Internet and proposes a concept of centralization of decentralization. In an embodiment, an online communication platform is provided which re-establishes transparency among different offers and allows formation of a fair price between sellers and buyers.

As indicated by a block 400, the seller nodes 104 mentioned above have a number of trading options. Each seller node 104 is indicated by a certain block 402, 404, 406 and is capable of placing seller offers 126 concerning certain groups of products.

As indicated by a block 410, there are trading options for products. According to a first block 412, a certain number of mobile phones are offered, for instance 1000. Another trading offer, see block 412, relates to 5000 of these mobile phones. Yet another trading offer, see block 416, relates to a number of other products, for instance 100 TVs. Via the communication architecture of exemplary embodiments, many potential buyers may form a group to buy a batch of products (see blocks 412, 414, 416) with the opportunity to obtain a discount in view of the large group of products bought by the buyers in combination.

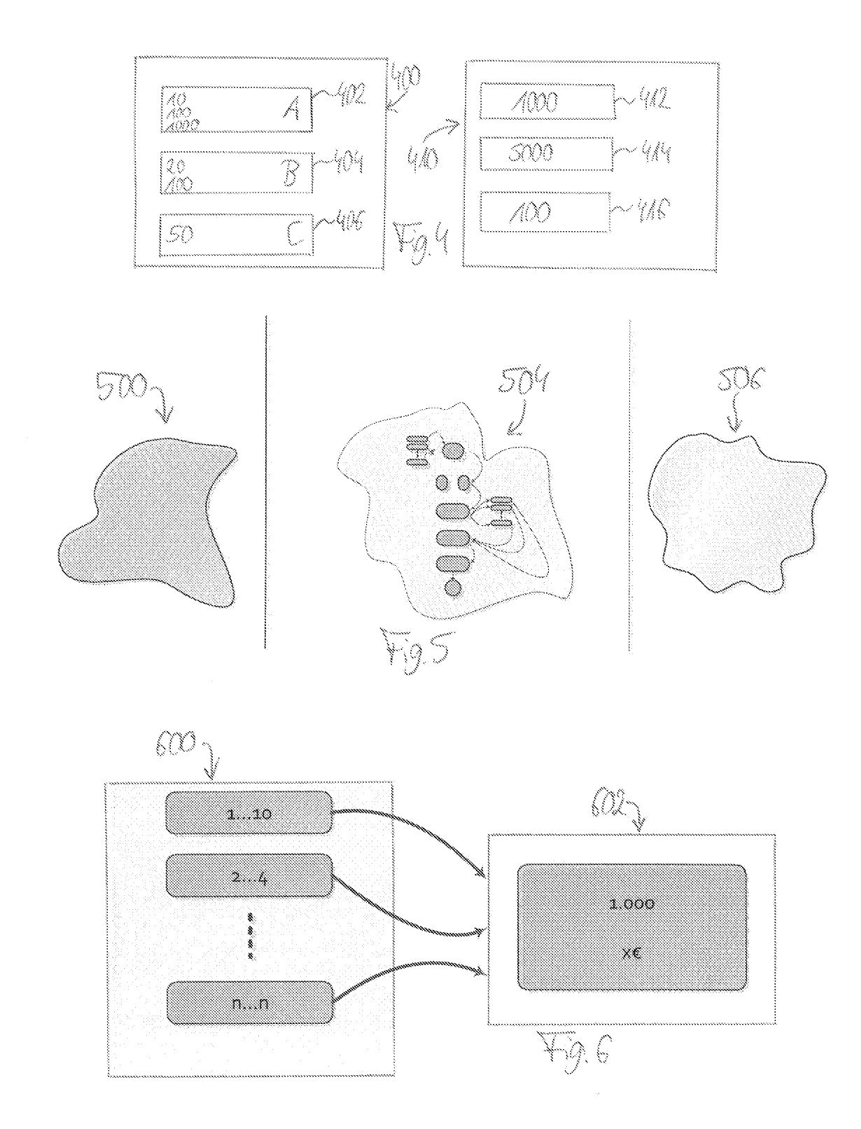

FIG. 5 schematically illustrates that exemplary embodiments of the invention offer the possibility to make

(a) trades using high volume options (see block 500),

(b) using acquisition options (see block 504); and/or

(c) trade with virtual products (see block 506).

What concerns a trade using high volume options (see block 500), if a seller node 104 has a certain product capacity and wishes to sell it as a batch, the seller node 104 may offer a corresponding seller offer 126 via the online platform.

For instance, a seller node 104 has a product A in an amount X for a price Y. Then, X buyer nodes 102 have the opportunity to buy this product A, each for the price Y. A large discount may be obtained for each individual buyer node 102, when many buyer nodes 102 together acquire a large number X of products A as a group.

In a portal or platform according to an exemplary embodiment of the invention, buyer nodes 102 can hence declare their intention to buy certain products. If one buyer node 102 wishes to buy a specific mobile phone, and offers a certain price provided that a certain number of further buyer nodes 102 (for instance 1000) also place corresponding buyer requests 124 concerning this product and price, corresponding seller offers 126 may be requested or may be awaited, and the cheapest offer may be accepted by the buyer group so that the acquisition may be made.

This ensures that consumers can obtain high volume discounts by solidarisation in a common buyer group.

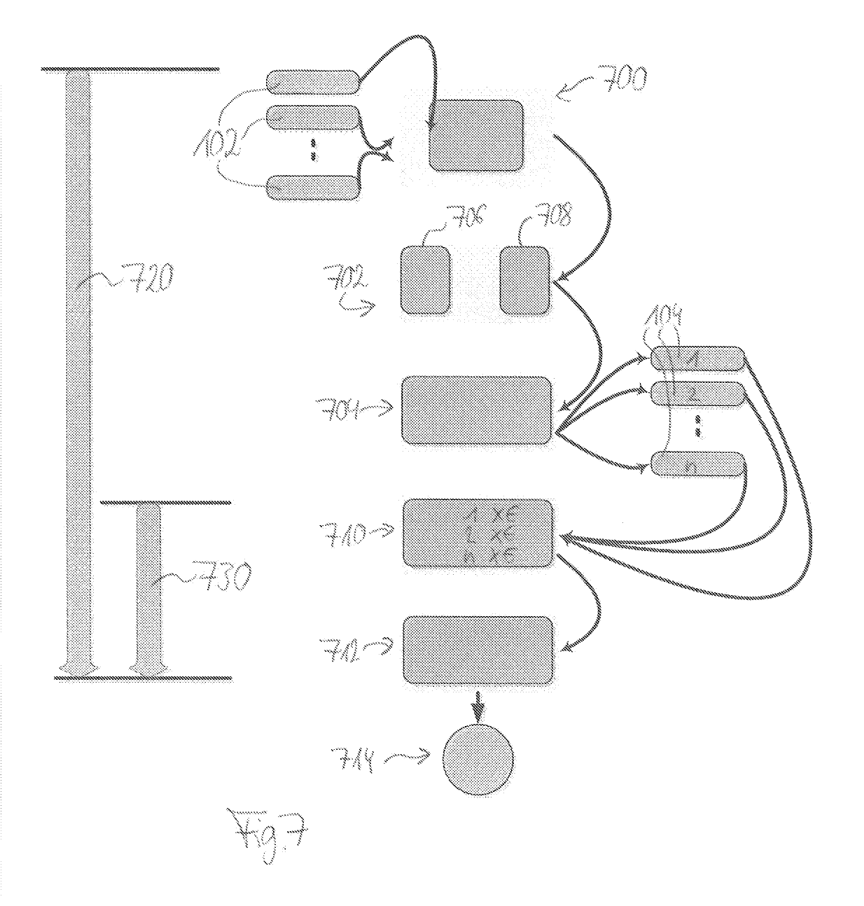

As indicated by the schematic illustration of FIG. 6, buyer groups 600 may get the opportunity to acquire a high volume of products, see block 602. For instance, 1000 lamps may be offered with a high volume discount for a price X. Each potential buyer operating a buyer node 102 may indicate the intention to acquire a certain number of lamps, for instance between 1 and 10 pieces, between 2 and 4 pieces, or more generally between n and n pieces. A seller node 104 has the opportunity to offer a defined number of products for a defined price for acquisition by a group of buyers, for instance the 1000 lamps to the buyer group 600. Hence, a high volume of products can be acquired also by a large number of individual buyers operating corresponding buyer nodes 102. This offers completely new trading opportunities and architectures.

In a scenario in which a buyer group 600 of buyer nodes 102 does not develop to be large enough to buy a very big group of products in accordance with a seller offer 126 of a seller node 104, it is possible that this is communicated to the seller node 104, so that the seller node 104 has the option to make a new seller offer 126 adjusted or adapted to the reduced number of products according to the buyer group 600.

A trade using acquisition options (see block 504) shall be described by an example:

For example, Paul (operating a buyer node 102) might have the intention to buy a certain mobile phone. Paul offers, if not already present, an auction with a precise product specification and a duration time. In the morning, Julia (operating another buyer node 102) declares her intention to buy the same mobile phone. She joins the buyer group founded by Paul. In the following days, 5000 other buyers (operating further buyer nodes 102) have decided to buy the same mobile phone and have thereby placed their corresponding buyer requests 124 on the platform as well. During the duration time of the buyer group, seller nodes 104 may offer 5002 of the specific mobile phone for a certain price. The cheapest offer may then be accepted by the buyer group.

A schematic diagram of a corresponding computer-implemented method according to an exemplary embodiment of the invention is shown in FIG. 7:

Potential buyers operating buyer nodes 102 may found a group of buyers, see block 700, linked by the common intention to buy a specific product. The buyer group is defined by the products to be bought by the buyer nodes 102 of the buyer group. As indicated in a block 702, the buyer group is formed (as a group of a common interest) by the number n of buyer nodes 102, see block 706, and the corresponding products, see block 708. This buyer group may make a common offer to buy n products x, see block 704. The various seller nodes 104 can make offers in the form of seller offers 710. The trade is completed, see block 712, when the seller offer 710 with the lowest price has been accepted by the buyer group. This ends the auction, see block 714.

As indicated by reference numeral 720, the method starts with trading option and ends with an actual trade. As indicated by reference numeral 710, the buyer group will have to confirm the trade (in particular in a legally binding way), at the latest when accepting one of the seller offers 710.

What concerns a (c) trade with virtual products (see block 506), the concept described under (a) may also be applied to products which are still under development, i.e. are still virtual and have not yet been available on the market in the past.

Virtual products may hence also be offered by the described communication architecture, in particular to support their entry on the market. For instance, a seller node 104 may offer a new innovative product with a certain amount for a certain price and may receive individual buyer requests 124 from interested buyer nodes 102, for instance each willing to buy one product. By this type of crowd cashing, new products can more easily enter the market.

Summarizing, there are many possibilities for communication media and communication networks over which the trading system according to exemplary embodiments of the invention may be implemented. Many different possibilities exist also in terms of times at which prices and/or price requests can be transferred into a buyer group.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

Implementation of the invention is not limited to the preferred embodiments shown in the figures and described above. Instead, a multiplicity of variants are possible which use the solutions shown and the principle according to the invention even in the case of fundamentally different embodiments.

1. An apparatus for brokering between buyer nodes and seller nodes in a communication system, the apparatus comprising:
a buyer node interface configured for receiving buyer requests from respective ones of the buyer nodes, each buyer request requesting buying a respectively specified product;
a seller node interface configured for receiving seller offers from respective ones of the seller nodes, each seller offer offering sale of a respectively specified group of products;
a buyer group formation unit configured for forming buyer groups, each formed by combining a plurality of the buyer requests meeting at least one common similarity criterion in terms of the products specified by the buyer requests of a respective buyer group;
a broker unit adapted for, upon determining a match between the products requested by the buyer requests of a buyer group and a group of products specified by a respective one of the seller offers, brokering a sale of the respective group of products from the seller node to the buyer nodes corresponding to the plurality of buyer requests of the respective buyer group via the communication network.

2. The apparatus of claim 1, wherein the broker unit is adapted for brokering the sale only upon additionally determining a match between prices offered by the buyer requests for the respective product of the buyer group and prices offered by the seller offer for the respective product group.

3. The apparatus of claim 1,
wherein the buyer node interface is configured for receiving a buyer group foundation request from a respective one of the buyer nodes defining a new buyer group to be founded in terms of type and amount of products and assigned prize or prize range;
wherein the buyer group formation unit is configured for founding the new buyer group in accordance with a received buyer group foundation request and for inviting further buyer nodes to send buyer requests joining the newly founded buyer group.

4. The apparatus of claim 3, wherein the buyer group formation unit is configured for terminating a newly founded buyer group when no match with a seller request is determined within a predefined time interval after foundation.

5. The apparatus of claim 1,
wherein the seller node interface is configured for receiving a buyer group foundation request from a respective one of the seller nodes defining a new buyer group to be founded in terms of type and amount of products and assigned prize or prize range;
wherein the buyer group formation unit is configured for founding the new buyer group in accordance with a received buyer group foundation request and for inviting buyer nodes to send buyer requests joining the newly founded buyer group.

6. The apparatus of claim 5, wherein the buyer group formation unit is configured for terminating a newly founded buyer group when no match with buyer requests is determined within a predefined time interval after foundation.

7. The apparatus of claim 1, wherein the broker unit is adapted for, in particular before or upon determining a match, invite at least one of the buyer nodes and the seller nodes to provide a legally binding confirmation of at least one of the buyer requests and the seller request, respectively.

8. The apparatus of claim 1, wherein the broker unit is adapted for, upon determining a match, inviting the buyer nodes to transfer a payment prize for the products of the respective group of products to a trust account or the seller node.

9. The apparatus of claim 1, wherein the broker unit is adapted for, upon determining a match, inviting the seller nodes to ship the products of the respective group of products from the seller node to a trustee destination or the buyer nodes corresponding to the plurality of buyer requests.

10. The apparatus of claim 1, being configured to be communicatively coupled to the seller nodes and the buyer nodes via the Internet.

11. The apparatus of claim 1, wherein the broker unit is adapted for, upon determining multiple matches, brokering the sale of the respective group of products from the seller node having offered the lowest prize for the group of products.

12. The apparatus of claim 1, wherein the buyer node interface is configured for extracting buyer node identities from the buyer requests.

13. The apparatus of claim 1, wherein the seller node interface is configured for extracting seller node identities from the seller requests.

14. The apparatus of claim 1, configured for operating without indicating an identity of a buyer node to a seller node or an identity of a seller node to a buyer node prior to at least one of payment and shipment.

15. The apparatus of claim 1, wherein the buyer group formation unit is configured for forming buyer groups by combining a plurality of the buyer requests with specified products which are identical.

16. The apparatus of claim 1, wherein the buyer group formation unit is configured for forming buyer groups by combining a plurality of the buyer requests with specified products which are different from one another but are all available from a common supply source.

17. A communication system, comprising:
an apparatus of claim 1 for brokering between buyer nodes and seller nodes in a communication network;
the buyer nodes communicatively coupled with the apparatus via the communication network; and
the seller nodes communicatively coupled with the apparatus via the communication network.

18. A computer-implemented method of brokering between buyer nodes and seller nodes in a communication system, the method comprising:
receiving buyer requests from respective ones of the buyer nodes, each buyer request requesting buying a respectively specified product;
receiving seller offers from respective ones of the seller nodes, each seller offer offering sale of a respectively specified group of products;
forming buyer groups, each formed by combining a plurality of the buyer requests meeting at least one common similarity criterion in terms of the products specified by the buyer requests of a respective buyer group;
upon determining a match between the products requested by the buyer requests of a buyer group and a group of products specified by a respective one of the seller offers, brokering a sale of the respective group of products from the seller node to the buyer nodes corresponding to the plurality of buyer requests of the respective buyer group via the communication network.

19. A computer-readable medium, in which a computer program of brokering between buyer nodes and seller nodes in a communication network is stored, which computer program, when being executed by a processor, is adapted to carry out or control a method of claim 18.

20. A program element of brokering between buyer nodes and seller nodes in a communication network, which program element, when being executed by a processor, is adapted to carry out or control a method of claim 18.
